(19) United States
(12) Patent Application Publication
(10) Pub. No.: US 2020/0223292 A1
(43) Pub. Date: Jul. 16, 2020

(54) AIR FILTER ASSEMBLY

(71) Applicant: Lear Corporation, Southfield, MI (US)

(72) Inventors: David Kazyak, Brighton, MI (US); Karl Henn, New Hudson, MI (US); Arjun Yetukuri, Rochester Hills, MI (US)

(21) Appl. No.: 16/249,324

(22) Filed: Jan. 16, 2019

(51) Int. Cl. B60H 3/06; B01D 46/46; B01D 46/42; B01D 46/00

(52) U.S. Cl. CPC B60H 3/0658; B01D 46/46; B01D 2279/50; B01D 46/002; B01D 46/429

(57) ABSTRACT

An air filter assembly includes a seat assembly, an air filter unit, and an electronic control unit. The seat assembly may include a seat base and/or a seat back. The air filter unit may be connected to the seat assembly. The electronic control unit may be configured to automatically control the air filter unit. The air filter assembly may include one or more sensors, and/or the electronic control unit may be configured to automatically control the air filter unit according to information from the one or more sensors. The one or more sensors may include a biometric sensor. The biometric sensor may be configured to detect a body odor of an occupant disposed on the seat assembly. The one or more sensors may include a position sensor. The electrical control unit may be configured to automatically control the air filter unit according to information from the position sensor.

### TECHNICAL FIELD

The present disclosure generally relates to an air filter assembly, including air filter assemblies that may be used in connection with vehicles.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some air filter assemblies may be relatively complex and/or may not provide sufficient functionality. Some air filter assemblies may not be configured to automatically filter air within a vehicle.

There is a desire for solutions/options that minimize or eliminate one or more challenges or shortcomings of seat assemblies. The foregoing discussion is intended only to illustrate examples of the present field and should not be taken as a disavowal of scope.

### SUMMARY

In embodiments, an air filter assembly may include a seat assembly, an air filter unit, and/or an electronic control unit. The seat assembly may include a seat base and/or a seat back. The air filter unit may be connected to the seat assembly. The electronic control unit may be configured to automatically control the air filter unit. The air filter assembly may include a sensor assembly that may include one or more sensors, and/or the electronic control unit may be configured to automatically control the air filter unit according to information from the sensor assembly. The sensor assembly may include a biometric sensor. The biometric sensor may be configured to detect a body odor of an occupant disposed on the seat assembly. The one or more sensors may include a position sensor. The electrical control unit may be configured to automatically control the air filter unit according to information from the position sensor.

With embodiments, the electronic control unit may be configured to activate the air filter unit when the seat assembly is in a low air quality zone. The electronic control unit may be configured to connect with a position sensor of a mobile device of an occupant. The electronic control unit may be configured to connect to a remote server that may include air quality information for a plurality of locations (e.g., an air quality database); and/or the electronic control unit may be configured to selectively activate the air filter assembly according to the air quality information. The air filter assembly may be configured to connect to a HVAC system of the vehicle. The one or more sensors may include an air quality sensor that may be disposed outside the vehicle. The electrical control unit may be configured to automatically control the air filter unit according to information from the air quality sensor. The one or more sensors may include a camera. The electrical control unit may be configured to automatically control the air filter unit according to information from the camera, and/or the information from the camera may include an indication of at least one of a sneeze, a cough, and/or a burp. The air filter unit may include an air inlet and an air outlet, and/or the air outlet may be disposed substantially at a top portion of the seat back. The air filter inlet may be disposed substantially in the seat base. The air filter unit may include a fan, and/or the air filter unit may be configured for air purification.

In embodiments, the air filter assembly may include a first air filter unit, a second air filter unit, and/or an electronic control unit. The first air filter unit may be configured for connection with a first seat and/or the first air filter unit may include a first sensor assembly. The second air filter unit may be configured for connection with a second seat, and/or the second air filter unit may include a second sensor assembly. The electronic control unit may be connected to the first air filter unit and/or the second air filter unit. The electronic control unit may be configured to automatically control the first air filter unit according to information from the first sensor assembly. The electronic control unit may be configured to automatically control the second air filter unit according to information from the second sensor assembly. The electronic control unit may be configured to automatically control the first air filter unit and/or the second air filter unit independently and/or such that the first air filter unit may be in an activated state while the second air filter is in a deactivated state. The electronic control unit may be configured to determine whether to activate the first air filter unit and/or the second air filter unit according to a first air quality associated with the first seat and/or a second air quality associated with the second seat.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1A is a side view generally illustrating an embodiment of an air filter assembly according to teachings of the present disclosure.

FIG. 1B, is a side view generally illustrating an embodiment of an air filter assembly according to teachings of the present disclosure.

FIG. 2 is a top view generally illustrating an embodiment of an air filter assembly according to teachings of the present disclosure.

FIG. 3 is a flow chart generally illustrating a method of operation of the air filter assembly according to teachings of the present disclosure.

FIG. 4 is a schematic generally illustrating an embodiment of an air filter assembly according to teachings of the present disclosure.

FIG. 5 is a schematic generally illustrating an embodiment of an air filter assembly according to teachings of the present disclosure.

FIG. 6 is a schematic generally illustrating an embodiment of an air filter assembly according to teachings of the present disclosure.

FIG. 7 is a top view generally illustrating an embodiment of an air filter assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

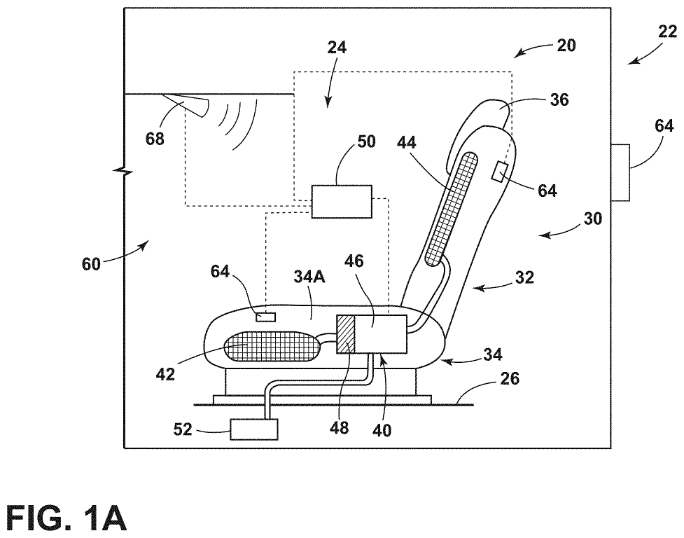

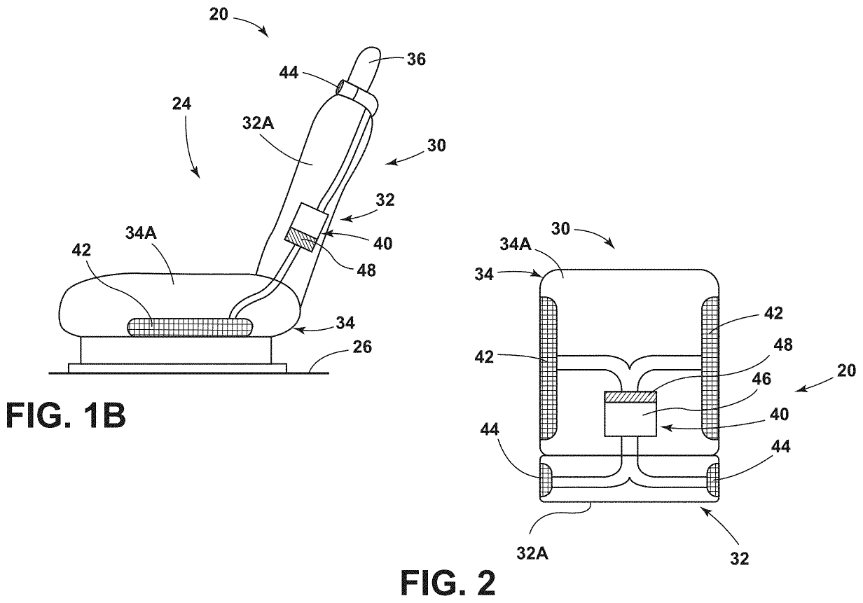

In embodiments, such as generally illustrated in FIGS. 1A, 1B, and 2, an air filter/purification assembly 20 may include a seat assembly 30, an air filter unit 40, an electronic control unit (ECU) 50, and/or a sensor assembly 60. The air filter unit 40 may be configured to filter air in an interior of a vehicle 22 (e.g., the vehicle cabin 24) and/or air at or about a seat assembly 30. The ECU 50 may be connected to the air filter unit 40 and may be configured to control (e.g., automatically), at least in part, operation of the air filter unit 40. The seat assembly 30 may include a seat back 32 and/or a seat base 34. The seat back 32 may be substantially vertical. The seat back 32 may be connected to a seat base 34. The seat base 34 may be substantially horizontal and/or connected to a mounting surface 26 (e.g., a vehicle floor). The air filter unit 40 may be connected to and/or disposed at least partially in the seat assembly 30.

With embodiments, the air filter unit 40 may be configured to filter and/or purify air (e.g., may include filters, antibacterial materials, ultraviolet (UV) light, etc.). The air filter unit 40 may include an inlet 42 and/or an outlet 44 (see, e.g., FIG. 1A, 1B, and 2). The inlet 42 may be configured to receive air of low quality, the air filter unit 40 may filter the air of low quality to provide air of higher quality, and the air filter unit 40 may expel air of higher quality from the seat assembly 30 via the outlet 44. The inlet 42 may be disposed at or about the seat base 34 and/or the seat back 32 (e.g., the inlet 42 may include a single section and/or may include a plurality of separate sections that may be disposed in various portions of a seat assembly 30). The outlet 44 may be disposed at or about the seat back 32 (see, e.g., FIG. 1A). The outlet 44 may be disposed and/or configured to expel air substantially between the seat back 32 and a headrest 36 connected to the seat back 32 (see, e.g., FIG. 1B). The inlet 42 and/or the outlet 44 may be integrated in a seat base cushion 34A and/or a seat back cushion 32A. In embodiments, the air filter unit 40 may include an air mover/fan 46. The fan 46 may include one or more of various types of air movers/fans 46, such as, for example and without limitation, a squirrel cage fan. The fan 46 may be configured to cause air (e.g., low quality air) to enter the inlet 42 and/or expel filtered air through the outlet 44. The air filter unit 40 may be configured for connection to a heating, ventilation, and air conditioning (HVAC) system 52 disposed at least partially in the seat assembly 30 and/or the vehicle 22. The air filter unit 40 may, for example, be connected to a fan 46 located in the HVAC system 52 and/or may include a filter attachment 48.

In embodiments, the ECU 50 may be connected to the air filter unit 40. The ECU 50 may be configured to control (e.g., automatically) the air filter unit 40. The ECU 50 may turn the air filter unit 40 on (e.g., an activated state) and/or off (e.g., a deactivated state). With embodiments, the ECU 50 may be configured to control a speed of the fan 46. The ECU 50 may be configured to operate the air filter unit 40 in a variety of modes. For example and without limitation, the modes may include a high speed mode, a medium speed mode, and/or a low speed mode (which may correspond to high, medium, and low fan speeds). The ECU 50 may determine a desired state or mode or operation for the air filter unit 40, and may then operate the air filter unit 40 in that state or mode. For example, the ECU 50 may activate the high speed mode for very low quality air, the medium speed mode for average low quality air, and/or the low speed mode for moderately low quality air. The ECU 50 may be connected (e.g., electrically, wirelessly, and/or via a wired connection) to the air filter unit 40. The ECU 50 may be disposed within the vehicle 22 and may be configured to control one or more other vehicle systems or components.

With embodiments, the air filter unit 40 may include a sensor assembly 60 that may include one or more sensors 62. The one or more sensors 62 may be disposed inside the vehicle cabin 24 and/or outside the vehicle cabin 24. The one or more sensors 62 may include one or more of a variety of sensors. For example, the one or more sensors 62 may include an air quality sensor 64, a position sensor 66 (e.g., a global positioning system or GPS sensor), a camera 68, microphone 70, and/or a biometric sensor 72, among others.

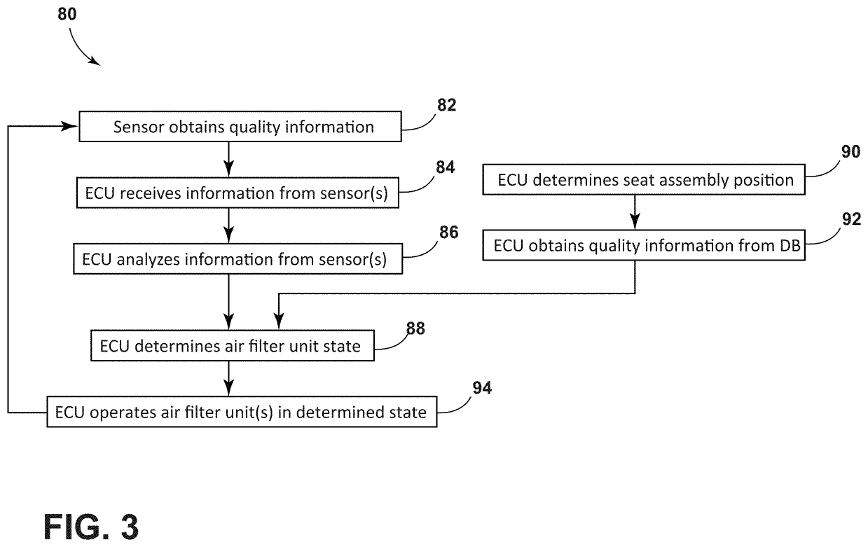

In embodiments, such as generally illustrated in FIG. 3, a method 80 of operating the air filter unit 40 may include the sensor assembly 60 obtaining information about the quality of the air near the seat assembly 30 and/or the vehicle 22 (step 82), such as in the vehicle cabin 24 and/or outside the vehicle 22. The ECU 50 may be configured to obtain information from the sensor assembly 60 about the quality of the air (step 84). The ECU 50 may analyze information from the sensor assembly 60 (step 86). The ECU 50 may determine a desired state of the air filter unit 40, which may include determining whether to turn the air filter unit 40 on and/or off, according to information from the sensor assembly 60 (step 88). The ECU 50 may the operate the air filter unit 40 according to the determined state (step 94). For example and without limitation, if the information from the sensor assembly 60 indicates that the quality of the air is below a threshold (or is likely to be below the threshold), the ECU 50 may turn the air filter unit 40 on, leave the air filter unit 40 on, change the mode of the air filter unit 40 (e.g., from low to medium, or from medium to high), and/or increase a fan speed of the air filter unit 40.

With embodiments, if the sensed air quality is significantly below the threshold, the ECU 50 may operate/turn on the air filter unit 40 in the high speed mode. If the difference between the sensed air quality and the threshold is moderate, the ECU 50 may operate/turn on the air filter unit 40 in the medium speed mode. If the difference between the sensed air quality and the threshold is small, the ECU 50 may operate/turn on the air filter unit 40 in the low speed mode. As the air filter unit 40 is operated, the air quality sensor 64 may sense that the air quality is improving, and the ECU 50 may change the mode of the air filter unit 40 (e.g., from the high speed mode to the moderate speed mode). Additionally or alternatively, if the information from the sensor assembly 60 indicates that the air quality is at or above the threshold, the ECU 50 may turn the air filter unit 40 off, leave the air filter unit 40 off, change the mode of the air filter unit 40 (e.g., from high to medium, or from medium to low), and/or decrease a fan speed of the air filter unit 40. The ECU 50 may periodically and/or continuously receive information from the sensor assembly 60 while controlling the air filter unit 40 until a desired air quality is achieved and/or to maintain air quality at an acceptable level.

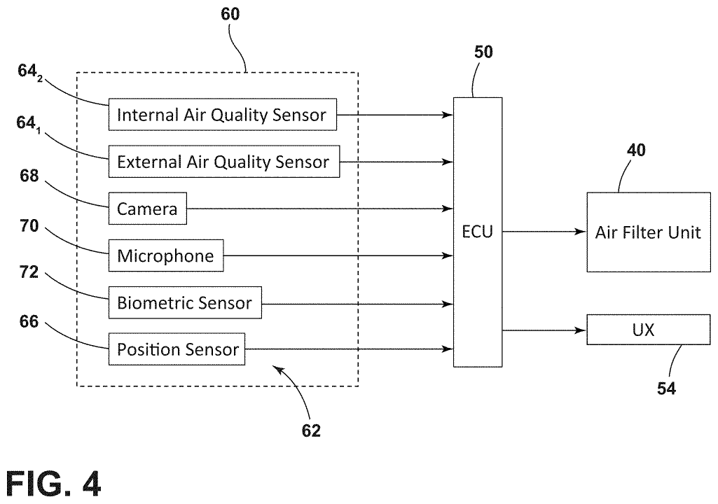

In embodiments, such as generally illustrated in FIG. 4, the sensor assembly 60 may include one or more air quality sensors 64 that may be configured to sense the quality of air proximate the sensor 64. An air quality sensor 64₁ may be disposed outside the vehicle 22 and may be configured to obtain information about the air quality of the exterior air (e.g., step 82 may include an air quality sensor 64₁ obtaining information about exterior air). Additionally or alternatively, an air quality sensor 64₂ may be disposed inside the vehicle 22, such as in the vehicle cabin 24 and/or the seat assembly 30 (e.g., step 82 may include an air quality sensor 642 obtaining information about interior air). The ECU 50 may be configured to control the air filter unit 40 according to information from the one or more air quality sensors 64.

In embodiments, such as generally illustrated in FIGS. 1A and 4, the sensor assembly 60 may include a camera 68. The camera 68 may be disposed within the vehicle cabin 24 and/or the camera 68 may be connected to the ECU 50. The ECU 50 may be configured to analyze information from the camera 68, such as to determine whether an occupant engages in an activity that is likely to be detrimental to air quality, such as sneezes, burps, coughs, eats, covers his/her nose or mouth (which may be indicative of bad odor), etc. The camera 68 may be connected to a microphone 70, and/or the microphone 70 may be connected to the ECU 50, such as to determine whether the occupant engages in a detrimental activity. The microphone 70 may be connected to an audio system of a vehicle 22, and/or the ECU 50 may be configured to filter out the audio (e.g., music) in the vehicle 22, such as to facilitate detection of a detrimental activity and/or avoid false positives. The ECU 50 may receive information from one or both of the camera 68 and the microphone 70 (e.g., in step 84) and may determine whether the occupant is engaging in a detrimental activity. When the ECU 50 determines that a detrimental activity is occurring, the ECU 50 may determine (e.g., in step 88) that the air filter unit 40 should be at least temporarily activated. The ECU 50 may combine/compare information from the camera 68 and the microphone 70 to confirm that an indication of poor air quality sensed by one of the camera 68 and the microphone 70 is accurate (e.g., to avoid false positives).

With embodiments, the camera 68 and/or microphone 70 may be configured to determine whether a pet (e.g., a dog, a cat, etc.) is in the vehicle 22. If a pet is in the vehicle 22, the ECU 50 may activate the air filter unit 40 while the pet is in the vehicle 22. The ECU 50 may keep the air filter unit 40 activated for a predetermined amount of time after the pet is no longer in the vehicle 22 (e.g., five minutes), such as to remove or filter hair, dander, pet breath, etc.

In embodiments, such as generally shown in FIG. 4, the sensor assembly 60 may include a biometric sensor 72. The biometric sensor 72 may be configured to detect a body odor, a humidity level (e.g., if the occupant is sweaty), and/or an occupant temperature. The biometric sensor 72 may be connected to the ECU 50 and the ECU 50 may receive information from the biometric sensor 72 about the occupant, such as in step 84, that may indicate that air quality may be below a desired/threshold level. The ECU 50 may be configured to analyze information from the biometric sensor 72 (e.g., in step 86), and/or determine a desired state of the air filter unit 40 according to the information from the biometric sensor 72 (e.g., in step 88). For example and without limitation, information from the biometric sensor 72 may indicate the presence of body odor, and the ECU 50 may activate the air filter unit 40 at least until the body odor is no longer sensed by the biometric sensor 72. In embodiments, the ECU 50 may analyze an ambient temperature, a humidity level (that may be determined via the biometric sensor 72 or a separate sensor 62), and/or the occupant temperature to determine whether the occupant is perspiring. For example and without limitation, if the humidity level, the occupant temperature, and/or the ambient temperature are above a threshold, the ECU 50 may turn on the air filter unit 40. The ECU 50 may turn on the air filter unit 40 until the occupant temperature drops below a threshold (e.g., a threshold where an occupant is not likely to be perspiring).

In embodiments, such as generally illustrated in FIG. 4, the sensor assembly 60 may include a position sensor 66 (e.g., a GPS sensor). The position sensor 66 may be configured to obtain information about a geographical location and/or position of the vehicle 22 and/or the seat assembly 30. The ECU 50 may be connected to the position sensor 66 and/or the ECU 50 may be configured to analyze information from the position sensor 66, such as to determine a position of the seat assembly 30 and/or the vehicle 22 (see, e.g., step 90 of method 80).

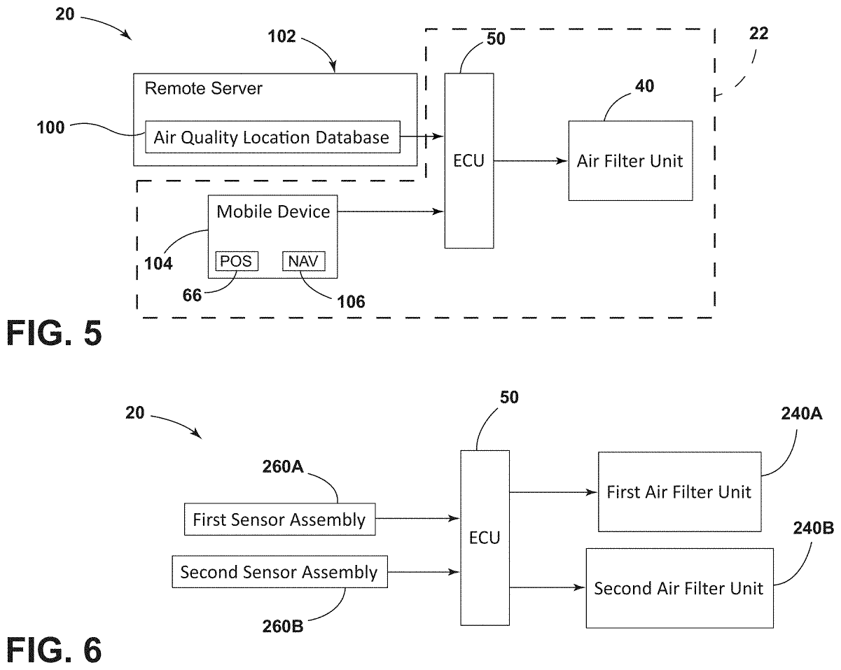

With embodiments, such as generally illustrated in FIG. 5, the ECU 50 may include and/or be connected to an air quality database 100. For example and without limitation, the air quality database 100 may be stored on a remote server 102 and the ECU 50 may be configured to communicate with the remote server 102 to access the air quality database 100. The ECU 50 may receive information from the air quality database 100 to determine whether the position of the seat assembly 30 is in a high air quality zone and/or a low air quality zone (see, e.g., step 92 of method 80). For example and without limitation, the ECU 50 may receive geographical zones that are known or likely to have low quality air. Additionally or alternatively, the ECU 50 may provide the current position of the seat assembly 30 to the air quality database 100, and the air quality database 100 may provide an indication of the expected air quality at that position. The ECU 50 may be configured to control the air filter unit 40 according to information from the air quality database 100. For example and without limitation, step 88 of method 80 may include the ECU 50 determining a state for the air filter unit 40 according to the position of the seat assembly 30/vehicle 22 and/or information from the air quality database 100. The ECU 50 may turn the air filter unit 40 on or up when the vehicle 22 enters a low air quality zone, and/or the ECU 50 may turn the air filter unit 40 off or down when the vehicle 22 enters a high air quality zone.

In embodiments, the ECU 50 may be in communication with a navigation system 106, such as of the vehicle 22 and/or a mobile device 104 of an occupant or of the vehicle 22. The ECU 50 may obtain expected route or position information from the navigation system 106. The ECU 50 may communicate with the navigation system 106 to determine if the seat assembly 30 is likely to enter a low air quality zone and may, proactively, turn the air filter unit 40 on or up before the seat assembly 30 enters the lower air quality zone. For example and without limitation, step 90 of method 80 may include determining a current position and/or expected positions (e.g., an expected route).

With embodiments, the ECU 50 may be configured to automatically activate when the vehicle/seat assembly 22, 30 leaves one or more specific locations. The specific locations may be stored in the ECU 50 (e.g., manually by an occupant) and/or in the air quality database 100. Additionally or alternatively, the ECU 50 may be configured to determine that the air quality inside and/or outside the vehicle 22 is typically low when the vehicle 22 leaves a location. The ECU 50 may automatically store that location (e.g., if the air quality is low at least two times when the vehicle 22 leaves the location). For example and without limitation, the one or more specific locations may include a gym and/or a restaurant that may be manually entered and/or that the ECU 50 may determine/learn that at least some specific locations are associated with lower air quality (e.g., bad breath, body odor, perspiration, etc.). In embodiments, step 88 of method 80 may include determining that the air filter unit 40 should be activated when the vehicle/seat assembly 22, 30 leaves a specific location.

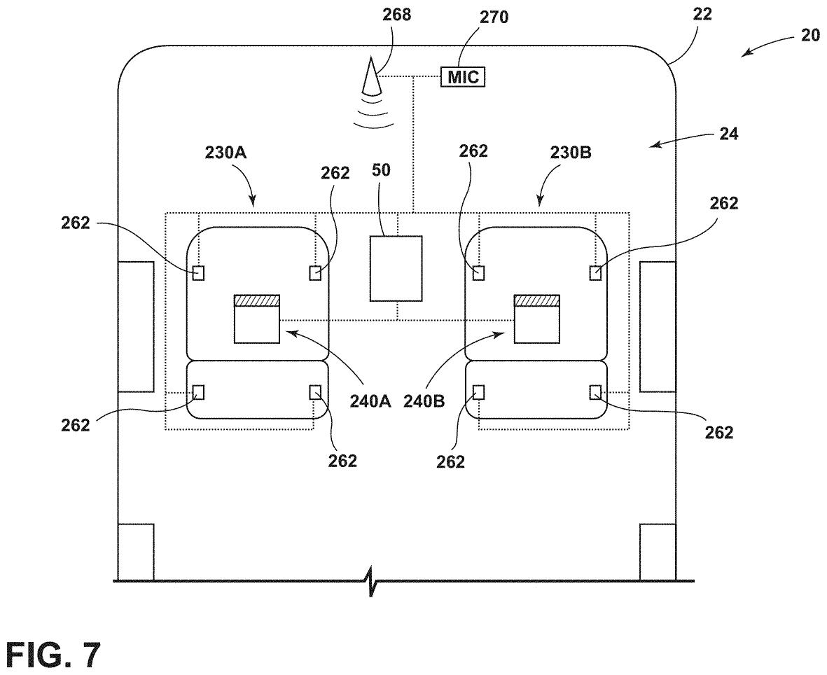

With embodiments, such as generally illustrated in FIGS. 6 and 7, an air filter assembly 20 may include a first air filter unit 240A connected to a first seat assembly 230A and/or a second air filter unit 240B connected to a second seat assembly 230B. The first air filter unit 240A and/or the second air filter unit 240B may be configured in the same or a similar manner as the air filter unit 40. The ECU 50 may be connected to the first air filter unit 240A and the second air filter unit 240B. The first air filter unit 240A may include and/or be connected a first sensor assembly 260A. The second air filter unit 240B may include and/or be connected to a second sensor assembly 260B. The first sensor assembly 260A and/or the second sensor assembly 260B may include one or more common sensors 262. For example and without limitation, a camera 268 and/or a microphone 270 disposed in the vehicle 22 may be used to sense conditions of the first seat assembly 230A and the second seat assembly 230B (or the vehicle 22 may include separate cameras 268 and microphones 270 for each seat assembly 230). The ECU 50 may be connected to the first sensor assembly 260A and/or the second sensor assembly 260B. The ECU 50 may be configured to analyze information from the first sensor assembly 260A and/or the second sensor assembly 260B to selectively turn on (e.g., activate) and/or off (e.g., deactivate) the first air filter unit 240A and/or the second air filter unit 240B. The ECU 50 may be configured to control the first air filter unit 240A and/or the second air filter unit 240B separately and/or simultaneously, which may include the first air filter unit 240A being on while the second air filter unit 240B is off. Additionally or alternatively, the ECU 50 may be configured to control the first air filter unit 240A and/or the second air filter unit 240B such that the first air filter unit 240A may be off while the second air filter unit 240B is on.

In embodiments, the ECU 50 may be configured to control the first air filter unit 240A and/or the second air filter unit 240B at different speeds. The ECU 50 may activate the first air filter unit 240A and/or the second air filter unit 240B at different speeds when the ECU 50 determines that the air quality at or about the first seat assembly 230A is different from the air quality at or about the second seat assembly 230B. For example and without limitation, the first air filter unit 240A may be in a high speed mode (e.g., low air quality) and/or the second air filter unit 240B may be in a low speed mode (e.g., moderate air quality). The first air filter unit 240A and/or the second air filter unit 240B may be configured to operate in a plurality of different modes (e.g., low speed mode, medium speed mode, and/or high speed mode) depending on a concentration of low air quality about an interior (e.g., vehicle cabin 24) of the vehicle 22. The ECU 50 may be configured to determine an internal zone of low air quality within the vehicle 22 and/or the ECU 50 may selectively activate the air filter unit(s) 240A, 240B in a high speed mode that are closer to the internal zone of low air quality than other air filter unit(s) 240A, 240B located farther from the low air quality zone.

With embodiments, such as generally illustrated in FIG. 4, the ECU 50 may be connected to a user interface (UX) 54 that may be configured to display information. For example and without limitation, the ECU 50 may be configured to display a current air quality, an initial/prior air quality, and/or a change in the air quality (e.g., a change caused by the air filter unit 40).

In embodiments, an ECU 50 may include an electronic controller and/or include an electronic processor, such as a programmable microprocessor and/or microcontroller. In embodiments, an ECU 50 may include, for example, an application specific integrated circuit (ASIC). An ECU 50 may include a central processing unit (CPU), a memory (e.g., a non-transitory computer-readable storage medium), and/or an input/output (I/O) interface (e.g., UX 54). An ECU 50 may be configured to perform various functions, including those described in greater detail herein, with appropriate programming instructions and/or code embodied in software, hardware, and/or other medium. In embodiments, an ECU 50 may include a plurality of controllers. In embodiments, the ECU 50 may be connected to a display, such as a touchscreen display (e.g., of the UX 54).

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

It should be understood that an electronic control unit (ECU) 50, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having both ROM, RAM, a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute one or more processors, multiple processors that are integrated into a single system or are distributed over and connected together through a communications network, and/or where the network may be wired or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An air filter assembly, comprising:
a seat assembly including a seat base and a seat back;
an air filter unit connected to the seat assembly; and
an electronic control unit;
wherein the electronic control unit is configured to automatically control the air filter unit.

2. The air filter assembly of claim 1, including a sensor assembly including one or more sensors; wherein the electronic control unit is configured to automatically control the air filter unit according to information from the one or more sensors.

3. The air filter assembly of claim 2, wherein the one or more sensors includes a biometric sensor.

4. The air filter assembly of claim 3, wherein the biometric sensor is configured to detect one or both of a body odor and a temperature of an occupant disposed on the seat assembly.

5. The air filter assembly of claim 2, wherein the one or more sensors includes a position sensor.

6. The air filter assembly of claim 5, wherein the electrical control unit is configured to automatically control the air filter unit according to information from the position sensor.

7. The air filter assembly of claim 6, wherein the electronic control unit is configured to activate the air filter unit when the seat assembly is in a low air quality zone.

8. The air filter assembly of claim 6, wherein the electronic control unit is configured to connect with a position sensor of a mobile device of an occupant and/or of a vehicle.

9. The air filter assembly of claim 6, wherein the electronic control unit is configured to connect to a remote server that includes air quality information for a plurality of locations; and the electronic control unit is configured to selectively activate the air filter assembly according to the air quality information.

10. The air filter assembly of claim 2, wherein the one or more sensors includes an air quality sensor disposed outside the vehicle; and the electrical control unit is configured to automatically control the air filter unit according to information from the air quality sensor.

11. The air filter assembly of claim 2, wherein the one or more sensors includes a camera.

12. The air filter assembly of claim 11, wherein the electrical control unit is configured to automatically control the air filter unit according to information from the camera; and the information from the camera includes an indication of at least one of a sneeze, a cough, or a burp.

13. A vehicle including the air filter assembly of claim 1, wherein the air filter assembly is configured to connect to a HVAC system of the vehicle.

14. The air filter assembly of claim 1, wherein the air filter unit includes an air inlet and an air outlet, and the air outlet is disposed substantially at a top portion of the seat back.

15. The air filter assembly of claim 14, wherein the air filter inlet is disposed substantially in the seat base.

16. The support assembly of claim 1, wherein the electronic control unit is connected to a user interface; and the electronic control unit is configured to display a current air quality, a prior air quality, and/or a change in air quality via the user interface.

17. The support assembly of claim 1, wherein the air filter unit is configured for air purification.

18. An air filter assembly, comprising:
a first air filter unit configured for connection with a first seat, the first air filter unit including a first sensor assembly;
a second air filter unit configured for connection with a second seat, the second air filter unit including a second sensor assembly; and
an electronic control unit connected to the first air filter unit and the second air filter unit;
wherein the electronic control unit is configured to automatically control the first air filter unit according to information from the first sensor assembly; and the electronic control unit is configured to automatically control the second air filter unit according to information from the second sensor assembly.

19. The air filter assembly of claim 18, wherein the electronic control unit is configured to automatically control the first air filter unit and the second air filter unit such that the first air filter unit is in an activated state while the second air filter is in a deactivated state.

20. The air filter assembly of claim 19, wherein the electronic control unit is configured to determine whether to activate at least one of the first air filter unit and the second air filter unit according to a first air quality of the first seat and a second air quality of the second seat.
